(19) United States
(12) Patent Application Publication
(10) Pub. No.: US 2018/0154972 A1
(43) Pub. Date: Jun. 7, 2018

(54) SUSPENSION FRICTION DRIVE AND AUTO-BALANCING TRANSPORATION DEVICE HAVING SAME

(71) Applicant: Shane Chen, Camas, WA (US)

(72) Inventor: Shane Chen, Camas, WA (US)

(21) Appl. No.: 15/807,570

(22) Filed: Nov. 8, 2017

Related U.S. Application Data
(60) Provisional application No. 62/418,826, filed on Nov. 8, 2016.

(51) Int. Cl. B62K 11/00; F16H 13/14; F16H 13/04; B62M 13/00; B62K 1/00; B62M 7/12; B62K 25/04

(52) U.S. Cl. CPC B62K 11/007; F16H 13/14; F16H 13/04; B62K 2025/042; B62K 1/00; B62M 7/12; B62K 25/04; B62M 13/00

(57) ABSTRACT

A suspension friction drive system and an auto-balancing personal transportation device having same. The suspension friction drive system may include two wheels (at least one of which is a drive wheel) that contact the rim of a wheel to be driven. The wheels preferably contact the rim at a contact angle that increases friction such that wheel driving performance is enhanced. The wheels are also preferably positioned such that some degree of shock absorption is provided and additional absorption may be supported. Various embodiments and features are disclosed including, but not limited to, a suspension frame coupled between the two wheels, the use of at least two drive wheels, a suspension bias mechanism, and a drive wheel substantially centered on the rim.

### CROSS REFERENCE TO RELATED APPLICATIONS

This application claims the benefit of U.S. Provisional Application No. 62/418,826, filed Nov. 8, 2016, entitled Suspension Friction Drive System and having the same inventor(s) as above.

### FIELD OF THE INVENTION

The present invention relates to a suspension friction drive system and auto-balancing personal transportation devices (and other devices) having same.

### BACKGROUND OF THE INVENTION

The prior art includes U.S. Pat. No. 8,807,250, issued to Shane Chen for a Powered Single-Wheeled Self-Balancing Vehicle for Standing User (the '250 patent). FIG. 1 of this patent shows a friction drive arrangement in a self-balancing personal transportation device. The friction drive arrangement of this figure is positioned such that the “contact angle,” the angle of the tangent line where the main force of the drive wheel contacts the rim, is approximately 0 degrees (from horizontal). This arrangement is prone to slipping, particularly when conditions are adverse, such as wet, or traversing uphill, etc.

Friction drive motors, however, are lightweight and highly efficient. Thus, there inability to work in an auto-balance transportation device of the prior art resulted in the use of heavier, less-efficient (and hence ride-time shortening) motors and heavier batteries to drive the less efficient motors. Thus, the failure of the drives was problematic in multiple ways.

I need exist for a friction drive arrangement that has increased friction (and/or less slippage). A need further exists to provide adequate friction drive while also providing some shock absorption.

### SUMMARY OF THE INVENTION

Accordingly, it is an object of the present invention to provide a friction drive system that overcomes the shortcomings of the prior art.

It is another object of the present invention to provide a friction drive system with enhanced friction and performance.

It is also an object of the present invention to provide a friction drive system that provided enhance drive performance and a level so shock absorption.

Such a friction drive system would provide enhance performance of an auto-balancing transportation device and result in transportation devices that are light-weight, easier to use, and more efficient, among other benefits.

These and related objects of the present invention are achieved by use of a friction drive system and auto-balancing vehicle having same as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIG. 1 is a perspective side view of an auto-balancing personal transportation device having a suspension friction drive system in accordance with the present invention.

FIGS. 2-3 are perspective views a friction drive system in accordance with the present invention.

FIG. 4 is a side elevation view of the friction drive system of FIGS. 2-3, while FIG. 5 is a cross sectional view thereof.

### DETAILED DESCRIPTION

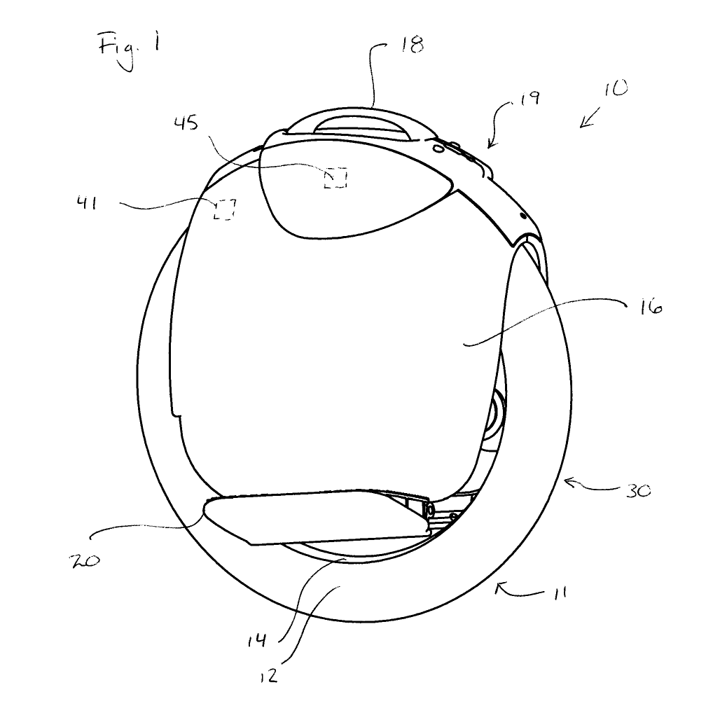

Referring to FIG. 1, a perspective side view of an auto-balancing personal transportation device 10 having a suspension friction drive system 50 in accordance with the present invention is shown. While suspension friction drive system 50 is taught in the context of an auto-balancing transportation device, it should be recognized that system 50 or the like may be implemented in a non-auto-balancing device without departing from the present invention.

Device 10 may include a wheel structure 11 having a tire 12 and a rim 14. A housing 16 covers a portion of the wheel structure and a handle 18 and user-interface 19 may be coupled to and/or formed on the housing. There are two foot platforms 20,30 located on opposite sides of the wheel structure (only one of which is shown) and these may be pivotally connected for movement between a deployed position and a retracted or stowed position (the deployed position is shown for platform 20).

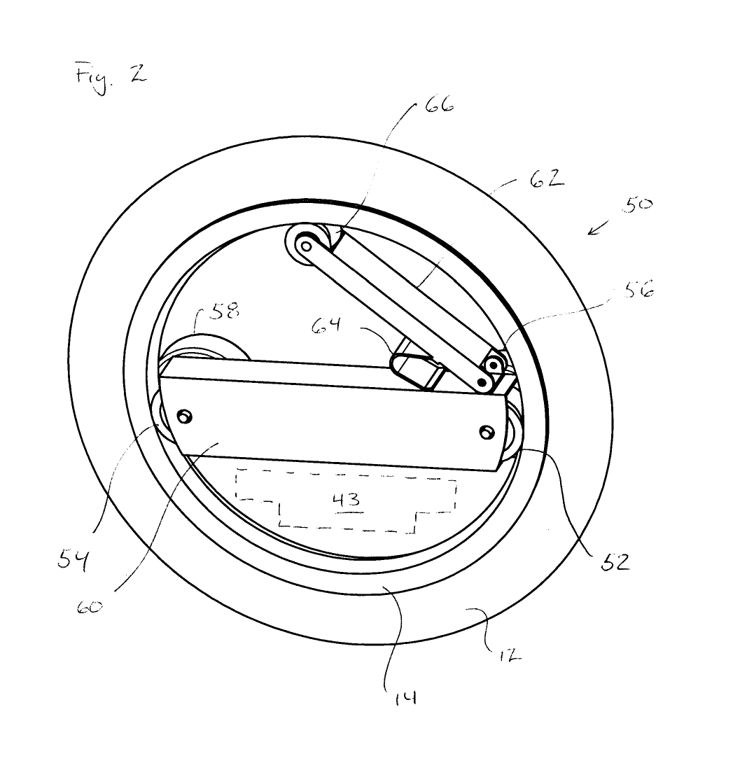

Device 10 further includes a position sensor 41, a battery 43 (see FIG. 2) and an electronic control circuit 45. The position sensor may be a gyroscopic sensor or other, and preferably provides an indication of the fore-aft pitch of device 10. The control circuit 45 preferably drives the device toward auto-balancing by controlling a drive mechanism (described below) based on a pitch position detected by the position sensor. The sensor 41 and control circuit 45 are shown representatively in phantom lines, located near a top region of the device (near the user control interface), in FIG. 1. They may be located in other locations including on frame 60 (FIG. 2) or elsewhere. Battery 43 may be provided below frame 60 and/or elsewhere.

Device 10 (other than as provided by the drive system described herein) may function in a manner very similar to that of the auto-balancing personal transportation device described in the '250 patent, which is mentioned above and hereby incorporated by reference.

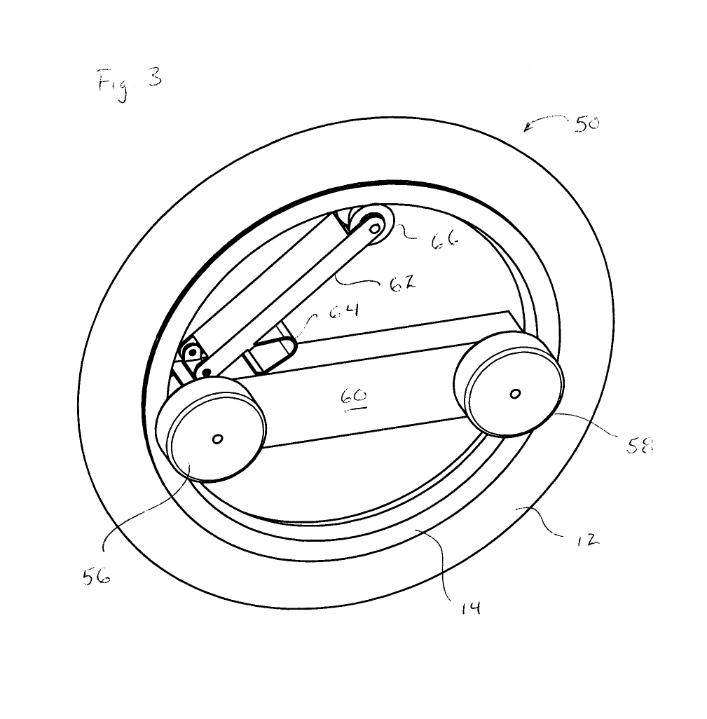

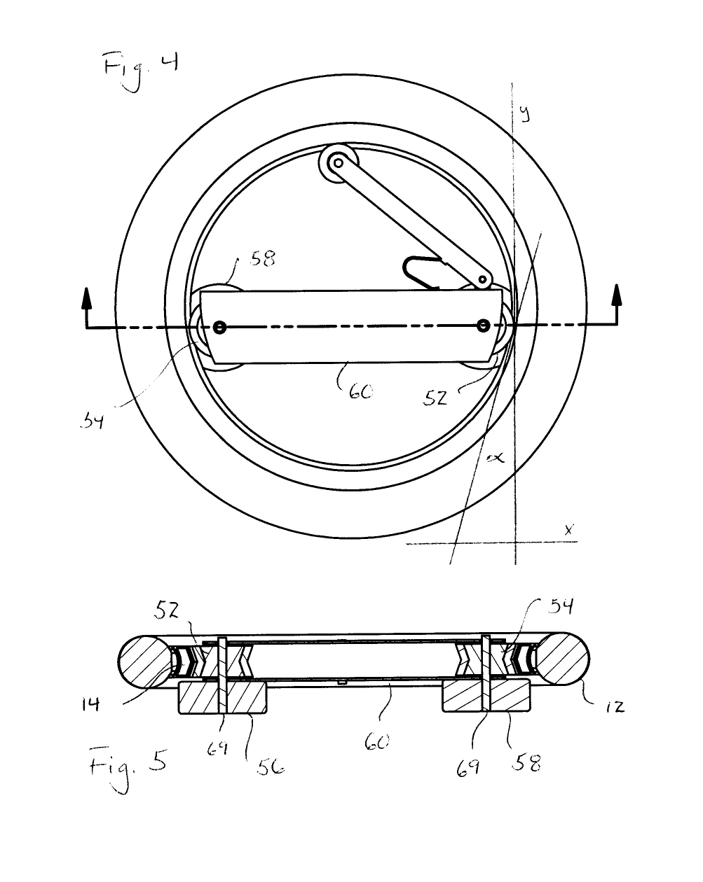

Referring to FIGS. 2-3, perspective views (from different lateral sides) of wheel structure 11 and friction drive system 50 of device 10 of FIG. 1 are shown. FIG. 4 is a side elevation view of the friction drive system, while FIG. 5 is a cross sectional plan view thereof.

System 50 may include first and second drive wheels 52,54, first and second motors 56,58, a frame 60, a suspension or bias arm 62, arm spring 64 and roller 66. Battery 43 is also shown.

In a preferred embodiment, frame 60 is positioned substantially horizontally so the drive wheels 52,54 contact rim 14 at a point forward and rearward in the device. As can be seen in FIG. 2 and FIG. 4, the outside distance from outer edge of the first to the second drive wheel may be nearly as long as the inner diameter of the rim. Arm spring 64 biases the bias arm and roller toward the rim and push the drive wheels into contact with rim 14. Further, the foot platforms are preferably either coupled directly to frame 60 or to housing 16 which is in turn coupled to frame 60, such that a user's weight on the foot platforms tends to pull the drive wheel vertically down and into contact with the rim (in the fore and rear positions shown in the figures, i.e., maintaining the frame in a substantially horizontal position.

The motors 56,58 are preferably mounted to frame 60 and have an axle 69 (FIG. 5) that is coupled to and transmits movement to drive wheels 52,54, respectively. Various motors are known in the art and may be used here, including hub motors, non-hub motors and others. Belts, gears or other suitable drive mechanisms may be employed. The rim may have a center ridge or be otherwise configured and the drive wheels complementarily configured with the rim.

When positioning the drive wheels as shown, several benefits are realized. FIG. 4 illustrates an angle, a, of the tangent line of contact of drive wheel 52 with rim 14. When this “contact angle” is approximately 70-80 degrees (from horizontal), the vertically of the contact increases friction over that in the prior art embodiment discussed above (0 degree contact angle). In addition, there is still a small about of vertical play in the position of the frame, i.e., the contact angle is not 90 degrees, and thus the frame and drive motor have some vertical play thereby allowing for shock absorption. In addition, since the drive wheels may be made of rubber or another material with some elasticity, this elasticity could participate in affording some shock absorption.

This contact angle of improved friction yet maintaining shock absorption may be from 45-85 degrees, or 60-80 degrees or, more preferably in the 70-80 degree range discussed above. It can also be less than 45 degrees, but the increase in friction will be less.

While two drive wheels and drive motors are shown, it should be realize that one of these could be a non-motorized guide wheel or the like. Two drive wheels provide some redundancy. Further, a single drive motor driving two drive wheel may be employed.

The surface of the drive wheel and rim may be smooth or roughed depending on the materials used to make the wheel or rim as is known in the art. For example, if a natural rubber is used, the rim may be smooth, yet if a synthetic rubber is used a somewhat abraded rim surface may be helpful.

While a single rim and tire are shown, the term single wheel structure as used herein is intended to cover the use of two tires on a single rim or other structures that approximate a single wheel in operation.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A suspension friction drive system, comprising:
a wheel having a rim;
a drive wheel; and
a drive motor;
wherein the drive wheel contacts the rim with a contact angle between 45 and 85 degrees.
